(19) United States
(12) Patent Application Publication
(10) Pub. No.: US 2026/0234984 A1
(43) Pub. Date: Aug. 13, 2026

(54) CONTROLLING A SLIDING DOOR COMPRISING A FIRST DOOR LEAF AND A SECOND DOOR LEAF

(71) Applicant: ASSA ABLOY AB, Stockholm (SE)

(72) Inventors: Roger Dreyer, Bjärred (SE); Kenneth Pernyer, Ängelsberg (SE); Gustav Ryd, Stockholm (SE)

(21) Appl. No.: 19/151,740

(22) PCT Filed: Feb. 1, 2024
(86) PCT No.: PCT/EP2024/052477

§ 371 Date: Jul. 29, 2025

(30) Foreign Application Priority Data
Feb. 13, 2023 (SE) 2350130-7

(51) Int. Cl. E05F 15/73

(52) U.S. Cl. CPC E05F 15/73; E05F 2015/767; E05Y 2900/132

(57) ABSTRACT

It is provided a method for controlling a sliding door comprising a first door leaf and a second door leaf. The method is performed by a door controller. The method comprises: determining a position of a person approaching sliding door, in relation to the sliding door; predicting an entry position, where the person is expected to enter through the sliding door, based on the position; determining a near door leaf, being the door leaf, of the first door leaf and the second door leaf, whose centre point, in a horizontal plane, is closer to the predicted entry position, and a far door leaf being the other door leaf, of the first door leaf and the second door leaf; and opening the sliding door asymmetrically, such that a near door leaf opens more than the far door leaf.

### TECHNICAL FIELD

The present disclosure relates to the field of a sliding door. and in particular to controlling a sliding door comprising a first door leaf and a second door leaf.

### BACKGROUND

Sliding doors are used in several different contexts. Motorized sliding doors are convenient, since they can be opened and closed automatically based on presence detection, to allow a person to pass through without needing to perform any other action than approaching the sliding door. Sliding doors can have one, two or more door leaves.

While sliding doors are convenient, they also contribute to energy consumption as climatised (heated or cooled) air escape through the doors when they open. Moreover, any improvement to user experience is of great value.

### SUMMARY

One object is to improve operation of a sliding door comprising two door leaves.

According to a first aspect, it is provided a method for controlling a sliding door comprising a first door leaf and a second door leaf. The method is performed by a door controller. The method comprises: determining a position of a person approaching sliding door, in relation to the sliding door; predicting an entry position, where the person is expected to enter through the sliding door, based on the position; determining a near door leaf, being the door leaf, of the first door leaf and the second door leaf, whose centre point, in a horizontal plane, is closer to the predicted entry position, and a far door leaf being the other door leaf, of the first door leaf and the second door leaf; opening the sliding door asymmetrically, such that a near door leaf opens more than the far door leaf; and closing the sliding door, such that a meeting point of the first door leaf and the second door leaf is offset from the middle towards the predicted entry position.

The opening the sliding door may comprise starting opening of the near door leaf prior to starting opening the far door leaf.

The method may further comprise: determining a trajectory of the person based on the position of the person in a series of images from an image capturing device being fixed in relation to the sliding door, in which case the predicting an entry position is based on the trajectory.

The entry position may be predicted to be on the side of a meeting point, of the first door leaf and the second door leaf, that is closer to the person.

The method may further comprise: closing the sliding door, such that a meeting point of the first door leaf and the second door leaf is offset from the middle towards the predicted entry position.

The meeting point may be determined based on a plurality of openings of the sliding door.

The method may further comprise: determining that a distance between the predicted entry position deviates from a meeting point of the first door leaf and the second door leaf is less than a threshold distance; determining a desired traffic flow. In this case, the opening the sliding door asymmetrically comprises opening the sliding door such that the door leaf, of the first door leaf and the second door leaf, that complies with the traffic flow opens more than the other door leaf, of the first door leaf and the second door leaf.

The determining a desired traffic flow may comprise determining that the desired traffic flow is one of right-hand and left-hand traffic flow.

The opening the sliding door may comprise opening the near door leaf in a direction away from the other door leaf, of the first door leaf and the second door leaf.

The opening the sliding door may comprise opening the near door leaf in a direction toward the other door leaf, of the first door leaf and the second door leaf.

According to a second aspect, it is provided a door controller for controlling a sliding door comprising a first door leaf and a second door leaf. The door controller comprises: a processor; and a memory storing instructions that, when executed by the processor, cause the door controller to: determine a position of a person approaching sliding door, in relation to the sliding door; predict an entry position, where the person is expected to enter through the sliding door, based on the position; determine a near door leaf, being the door leaf, of the first door leaf and the second door leaf, whose centre point, in a horizontal plane, is closer to the predicted entry position, and a far door leaf being the other door leaf, of the first door leaf and the second door leaf; open the sliding door asymmetrically, such that a near door leaf opens more than the far door leaf; and close the sliding door, such that a meeting point of the first door leaf and the second door leaf is offset from the middle towards a side of the door leaf, of the first door leaf and the second door leaf, that was opened more than the other door leaf, of the first door leaf and the second door leaf.

The instructions to open the sliding door may comprise instructions that, when executed by the processing circuitry, cause the door controller to start opening of the near door leaf prior to starting opening the far door leaf.

The door controller may further comprise instructions that, when executed by the processor, cause the door controller to determine a trajectory of the person based on a series of images from an image capturing device being fixed in relation to the sliding door. In this case, the instructions to predict an entry position comprise instructions that, when executed by the processor, cause the door controller to predict an entry position is based on the trajectory.

The instructions to predict an entry position may comprise instructions that, when executed by the processor, cause the door controller to predict the entry position to be on the side of a meeting point, of the first door leaf and the second door leaf, that is closer to the person.

The door controller may further comprise instructions that, when executed by the processor, cause the door controller to: close the sliding door, such that a meeting point of the first door leaf and the second door leaf is offset from the middle towards a side of the door leaf, of the first door leaf and the second door leaf, that was opened more than the other door leaf, of the first door leaf and the second door leaf.

The meeting point may be determined based on a plurality of openings of the sliding door.

The door controller may further comprise instructions that, when executed by the processor, cause the door controller to: determine that a distance between the predicted entry position deviates from a meeting point of the first door leaf and the second door leaf is less than a threshold distance; determine a desired traffic flow. In this case, the instructions to open the sliding door asymmetrically comprise instructions that, when executed by the processor, cause the door controller to open the sliding door such that the door leaf, of the first door leaf and the second door leaf, that complies with the traffic flow opens more than the other door leaf, of the first door leaf and the second door leaf.

According to a third aspect, it is provided a sliding door comprising: a first door leaf; a second door leaf; and a door controller according to the second aspect for controlling the sliding door.

According to a fourth aspect, it is provided a computer program for controlling a sliding door comprising a first door leaf and a second door leaf. The computer program comprises computer program code which, when executed on a door controller causes the door controller to: determine a position of a person approaching sliding door, in relation to the sliding door; predict an entry position, where the person is expected to enter through the sliding door, based on the position; determine a near door leaf, being the door leaf, of the first door leaf and the second door leaf, whose centre point, in a horizontal plane, is closer to the predicted entry position, and a far door leaf being the other door leaf, of the first door leaf and the second door leaf; open the sliding door asymmetrically, such that a near door leaf opens more than the far door leaf; and close the sliding door, such that a meeting point of the first door leaf and the second door leaf is offset from the middle towards a side of the door leaf, of the first door leaf and the second door leaf, that was opened more than the other door leaf, of the first door leaf and the second door leaf.

According to a fifth aspect, it is provided a computer program product comprising a computer program according to the fourth aspect and a computer readable means comprising non-transitory memory in which the computer program is stored.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

Aspects and embodiments are now described, by way of example, with reference to the accompanying drawings, in which:

FIG. 1 is a schematic diagram showing an environment in which embodiments presented herein can be applied;

FIGS. 2A-D are schematic top-view diagrams illustrating an embodiment when a person approaches the sliding door from one side;

FIGS. 3A-B are schematic top-view diagrams illustrating an embodiment when a person approaches the sliding door straight on;

FIG. 4 is a flow chart illustrating methods for controlling a sliding door comprising a first door leaf and a second door leaf;

FIG. 5 is a schematic diagram illustrating components of the door controller of FIG. 1; and

FIG. 6 shows one example of a computer program product comprising computer readable means.

### DETAILED DESCRIPTION

The aspects of the present disclosure will now be described more fully hereinafter with reference to the accompanying drawings, in which certain embodiments of the invention are shown. These aspects may, however, be embodied in many different forms and should not be construed as limiting; rather, these embodiments are provided by way of example so that this disclosure will be thorough and complete, and to fully convey the scope of all aspects of invention to those skilled in the art. Like numbers refer to like elements throughout the description.

In embodiments presented herein, for a sliding door with multiple door leaves, the door leaves are opened asymmetrically when an approaching person is predicted to enter in an entry position that is offset from the centre of the sliding doors. For instance, if the person is approaching from the right and the person is predicted to enter through the sliding door on the right, the right door leaf is opened more than the left door leaf. The asymmetric approach of the person can be due to the static structure of buildings and installations, and/or due to temporary interfering objects. Compared to traditional, symmetric, opening, this results in a more convenient opening experience. Additionally, the opening may not be as big compared to a symmetric opening, since the opening is tailored based on the location and predicted entry position of the approaching person. Additionally, the door leaves may not need to open as much, resulting in less leakage of climatised air through the door.

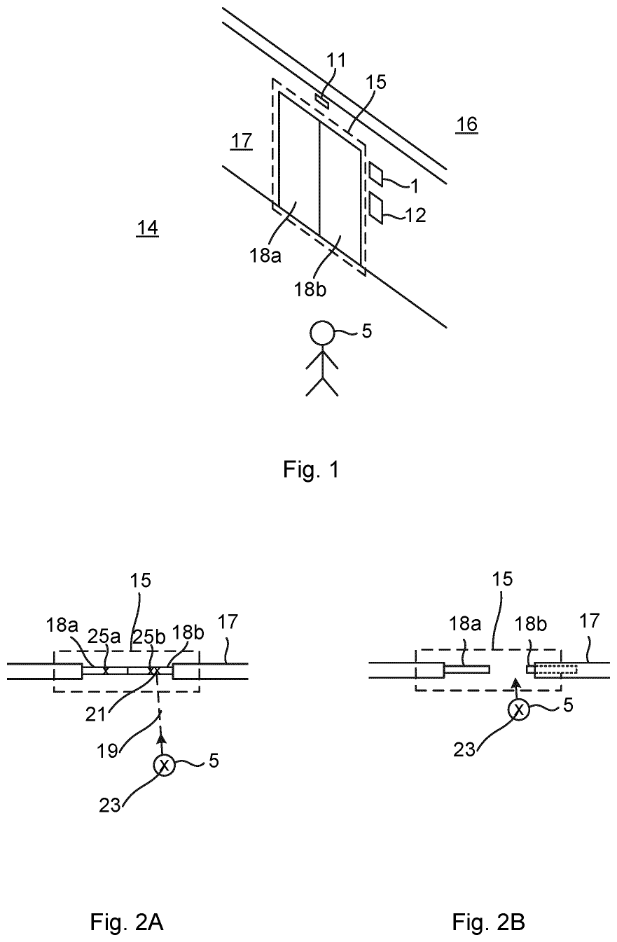

FIG. 1 is a schematic diagram showing an environment in which embodiments presented herein can be applied. Access to a physical space 16 is controlled by a sliding door 15, which is optionally selectively unlockable. The sliding door 15 stands between a first physical space 14 and a second physical space 16. The sliding door 15 comprises at least two door leaves 18a-b, a first door leaf 18a and a second door leaf 18b, but may optionally comprise more door leaves (not shown).

Optionally, in order to control access to the second physical space 16, an electronic lock 12 can be provided to selectively unlock the door 15. In this case, the electronic lock 12 is controllable to be in a locked state or in an unlocked state. The electronic lock 12 can evaluate access of a person 5 by communicating with an electronic key (not shown) of the person 5, or using biometrics. Alternatively or additionally, the person 5 may need to enter a personal identification number (PIN) for access. Alternatively or additionally, access through the door 15 can be provided using a traditional, mechanical, lock.

In the example illustrated by FIG. 1, there is one person 5 in the vicinity of the sliding door 15. However, it is to be noted that embodiments presented herein are applicable for any number of people around the sliding door 15.

According to embodiments presented herein, it is provided a door controller 1 for controlling the opening and closing of the door leaves 18a-b of the sliding door 15. This is based on one or more images (e.g. a video sequence) captured by an image capturing device 11, wherein the one or more images are provided to the door controller 1. The image capturing device 11 can be a camera, radar, infrared sensor, or UWB (ultra-wideband) sensor, etc. While FIG. 1 only shows one image capturing device 11, in the first physical space 14, there can also be a corresponding image capturing device in the second physical space 16. As explained in more detail below, the door opening of the sliding door 15 is asymmetrically controlled based on a predicted entry position, where the person 5 is expected to enter through the sliding door 15. The door controller 1 can be provided as a stand-alone device, or the door controller 1 can be integrated with the sliding door 15 or the electronic lock 12, when provided.

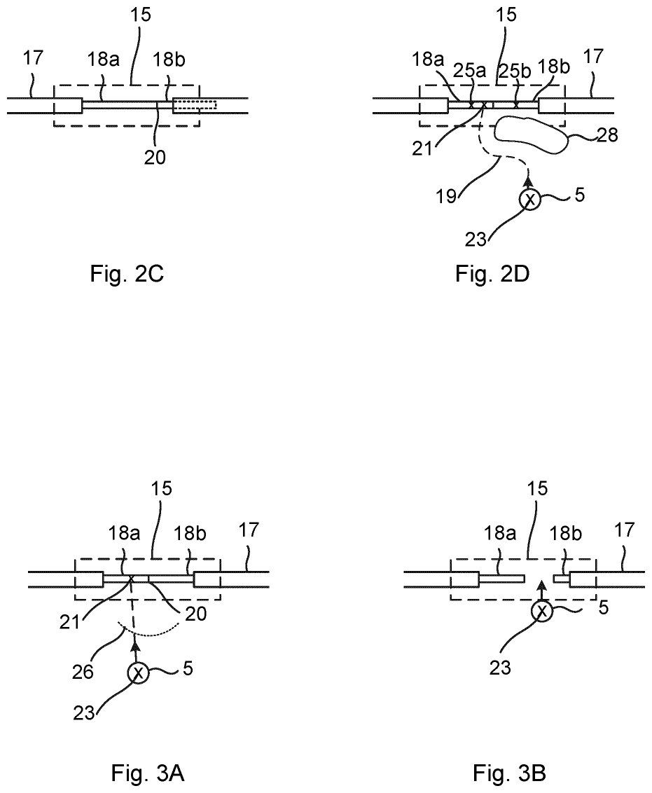

FIGS. 2A-D are schematic top-view diagrams illustrating an embodiment when a person approaches the sliding door 15 from one side. In this schematic top view, a person is here represented by a circle. The predicted entry position 21 is indicated, which is the position where the door controller 1 predicts that the person 5 will enter through the sliding door 15 via a straight predicted trajectory 19. Arrows indicate a movement direction. The position 23 and predicted entry position 21 of the person is determined based on the one or more images captured by the image capturing device(s) 11 and analysed by the door controller 1. A first door leaf 18a is shown with its first centre point 25a and a second door leaf 18b is shown with its second centre point 25b. The centre points 25a, 25b are the geometric centres of the respective door leaf 18a, 18b, in a horizontal plane, i.e. in the plane of the paper on which FIG. 2A is depicted. The centre points 25a, 25b can be determined based on either the exposed part of the respective door leaf 18a, 18b or on the entire respective door leaf 18a, 18b.

In FIG. 2A, the person 5 is shown to approach the sliding door 15 from the right. More specifically the person 5 in a certain position 23 is moving towards the sliding door 15, and the predicted entry position 21 is in a position where the person would enter through the sliding door 21 if the person 5 continues along a predicted trajectory 19 in the same movement direction. It is to be noted that the position 23 of the person 5 can be defined in any suitable way, e.g. in relation to the sliding door 15 or surrounding structure 17, as long as it can be deduced where the person 5 is located in relation to the sliding door 15

According to embodiments presented herein, the door controller 1 opens the door leaf that is closer to the person 5 more than the other door leaf, determined based on the predicted entry position 21. Specifically, a near door leaf is determined to be the door leaf whose centre point (in a horizontal plane, i.e. in the plane of the paper of FIG. 2A) is closer to the predicted entry position. The other door leaf is denoted a far door leaf. In this example, the predicted entry position of person 5 is closer to the centre point 25b of the second door leaf 18b than the centre point 25a of the first door leaf 18a. Consequently, the second door leaf 18b is the near door leaf and will be opened more than the first door leaf 18a.

In FIG. 2B, compared to FIG. 2A, the person 5 has now come closer to the sliding door 15. It can here be seen that the second door leaf 18b has opened while the first door leaf 18a has remained in the same opening/closing state as in FIG. 2A.

This allows the person 5 to conveniently pass through the sliding door 15, passing through the opening that is provided by opening the second door leaf 18b. Additionally, the opening can be smaller than if both door leaves are opened completely, thereby reducing the amount of climatised (heated or cooled) air that can escape.

It is to be noted that the far door leaf that is further away, i.e. the first door leaf 18a in this example, can also be opened, as long as it is not opened more than the near door leaf that is closer to the person 5.

FIG. 2C illustrates an optional embodiment for door closing. In this embodiment, when the door leaf/leaves close, they close such that a meeting point 20 between the first door leaf 18a and the second door leaf 18b is offset from the middle of the opening of the sliding door 15, towards a side of the door leaf that was opened more than the other door leaf. Hence, building on the example of FIGS. 2A-B, the second door leaf 18b was opened more, whereby the door leaves 18a-b are closed such that the meeting point 20 towards the side of the second door leaf 18b.

FIG. 2D illustrates an optional embodiment for managing a situation with an obstacle 28. The obstacle 28 lies between the person 5 and the sliding door. More specifically, even though the person 5 is geometrically closer to the second door leaf 18b, the obstacle 28 is in the way. Hence, a trajectory 19 is predicted such that a predicted entry position 21 is to the left, where the first door leaf 18a is located. The predicted trajectory 19 and/or the predicted entry position 21 can be determined based on a machine learning model, where the obstacle 28 may not be needed to be explicitly determined. Instead, the obstacle 28 results in actual trajectories that avoid the obstacle 28. These actual trajectories, along with an actual entry position (and optionally actual trajectories to the actual entry position) can be used to train the machine learning model to predict the entry position (and optionally the trajectory) based on a position 23 of the person 5, and optionally also based on past actual trajectory of the person 5.

FIGS. 3A-B are schematic top-view diagrams illustrating an embodiment when a person approaches the sliding door 15 (more or less) straight on. Also here, a person 5 is represented by a circle and arrows indicate a movement direction.

In FIG. 3A, the person 5 is shown to approach the sliding door 15 and the person 5 is in a position 23 that is relatively far from the meeting point 20 of the first door leaf 18a and the second door leaf 18b. More specifically, a threshold distance 26 is defined from the meeting point 20. When the position 23 of the person 5 is further away from the meeting point 20 than the threshold distance 26, a desired traffic flow can be applied.

In this embodiment, when the person is further away than the threshold distance 26, the asymmetric door opening is performed based on a desired traffic flow (of people). The desired traffic flow can e.g. be right-hand traffic or left-hand traffic based on the country in which the sliding door 15 is installed. In the example illustrated by FIGS. 3A-B, the desired traffic flow is right-hand traffic. Hence, in the example depicted in FIGS. 3A-B, the second door leaf 18b will be opened more, even though the predicted entry position 21 is closer to the centre position (not shown) of the first door leaf 18a.

In FIG. 3B, illustrating the scenario of FIG. 3A but at a later point in time, the person 5 has come closer to the sliding door 15. It can here be seen that the second door leaf 18b has opened while the first door leaf 18a has remained in the same state as in FIG. 3A. Hence, the right-hand traffic flow is thereby enforced, even though the person 5 was approaching towards the left-hand door leaf in FIG. 3A. In this way, if another person approaches on the opposite side of the sliding door 15, that person will naturally keep to the right, whereby the right-hand traffic flow is ensured.

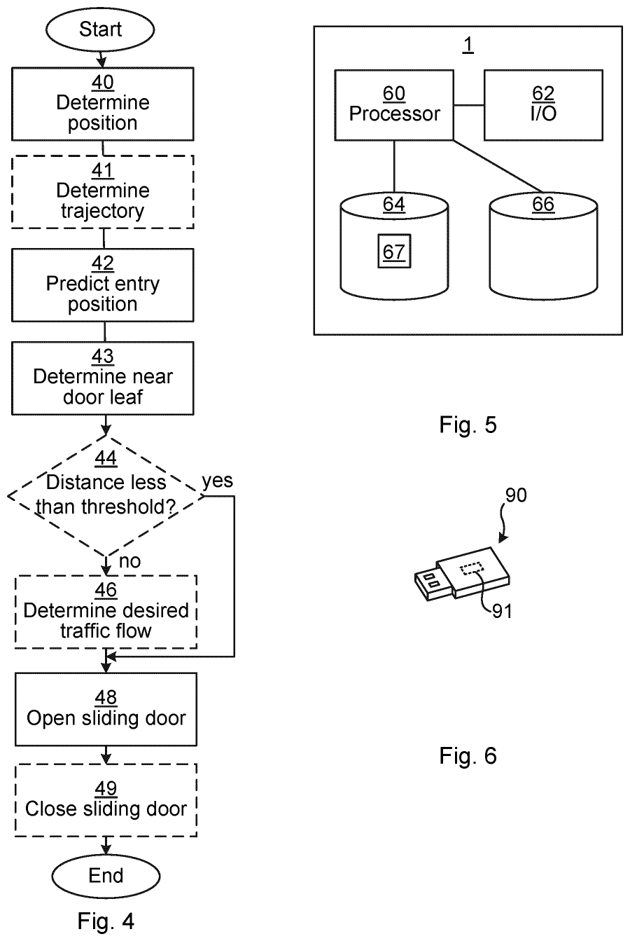

FIG. 4 is a flow chart illustrating methods for controlling a sliding door 15 comprising a first door leaf 18a and a second door leaf 18b. The method is performed by a door controller 1. The method can be performed for each image captured by the image capturing device(s), or once every n number of images that are captured by the image capturing device(s), where n is a configurable integer. The method can be repeated continuously or can be performed only when a person is found in an image provided by the image capturing device(s).

In a determine position step 40, the door controller 1 determines a position of a person 5 approaching sliding door, in relation to the sliding door (15), e.g. as shown in FIG. 2A and explained above.

In an optional determine trajectory step 41, the door controller 1 determines a trajectory of the person based on the position of the person 5 in a series of images. The images are obtained from an image capturing device 11 that is fixed in relation to the sliding door 15. For instance, the door controller 1 can obtain a sequence of images from the image capturing device 11 to determine the trajectory of the person over time. The trajectory reflects movement that the person 5 has performed over a certain time. By using a trajectory reflecting where the person 5 has been in the past, a more accurate prediction of entry position can be performed in a predict entry position step 42 (see next step).

In a predict entry position step 42, the door controller 1 predicts an entry position, where the person is expected to enter through the sliding door 15. The prediction is based on the position of the person and the trajectory (when the determine trajectory step 41 is performed). The entry position 21 can be predicted based on a machine learning model that is continuously trained based on people movements around the door, e.g. as illustrated in FIG. 2D, described above.

In a determine near door leaf step 43, the door controller 1 determines (which one of the door leaves that is) a near door leaf. The near door leaf is the door leaf, of the first door leaf 18a and the second door leaf 18b, whose centre point, in a horizontal plane, is closer to predicted entry position. A far door leaf is thus the other door leaf, of the first door leaf 18a and the second door leaf 18b, that is not the near door leaf.

The entry position can be predicted to be on the side of a meeting point 20 (of the first door leaf 18a and the second door leaf 18b) that is closer to the person 5. The meeting point can be determined based on a current closed meeting point 20 of the door leaves 18a, 18b, or determined based on an expected future meeting point 20 when the sliding door is open. Optionally, the meeting point 20 is determined based on a plurality of openings of the sliding door 15, e.g. based on a (mathematical) sliding window function.

In an optional conditional distance less than threshold step 44, the door controller 1 determines whether a distance between the position 23 of the person 5 and a meeting point 20 (of the first door leaf 18a and the second door leaf 18b) is less than a threshold distance. This exploits the relative lateral mobility of an approaching person when the person is further away (than the threshold distance) from the sliding door, since at such a point, the approaching person can more easily adjust his/her trajectory compared to if the person 5 is very close to the sliding door.

If the distance between the position of the person and the meeting point is greater than the distance threshold, the method proceeds to an optional determine desired traffic flow step 46. Otherwise, the method proceeds to an open sliding door step 48.

In the optional determine desired traffic flow step 46, the door controller 1 determines a desired traffic flow. The desired traffic flow can be determined to be one of right-hand and left-hand traffic flow, e.g. based on local traffic rules. The desired traffic flow is a configurable parameter.

In the open sliding door step 48, the door controller 1 opens the sliding door 15 asymmetrically, such that a near door leaf, opens more than the far door leaf, e.g. as shown in FIG. 2B and explained above.

Optionally, the opening the sliding door comprises starting opening of the near door leaf prior to starting the opening the far door leaf. In other words, the near door leaf is then opened first. This can be particularly useful when combined with the optional determine desired traffic flow step 46, to encourage the person to follow the desired path through the sliding door.

Optionally, the opening the sliding door comprises starting opening of the near door leaf at a greater opening speed than the opening the far door leaf. In other words, the near door leaf is then opened faster than the far door leaf.

Optionally, the timing of opening is dynamically determined. For instance, the opening can start early and fast to encourage a continuation of the intention indicated by the trajectory of the person. On the other hand, the opening can be slower and/or later when such encouragement is not needed, thereby saving energy.

When the determine desired traffic flow step 46 is performed, the opening the sliding door 15 asymmetrically comprises opening the sliding door 15 such that the door leaf (of the first door leaf 18a and the second door leaf 18b) that complies with the traffic flow opens more than the other door leaf (of the first door leaf 18a and the second door leaf 18b). In this way, when the predicted position is only slightly off from the meeting point 20 of the door leaves, the desired traffic flow can be enforced without significant negative effect on the approaching person. This is illustrated in FIGS. 3A-B, described above.

Optionally, each one of the door leaves 18a-b can be opened in either direction. Hence, the opening the sliding door can comprise opening the near door leaf in a direction away from the other door leaf, of the first door leaf 18a and the second door leaf 18b, which is the traditional scenario where door leaves open outwards.

Alternatively, the opening the sliding door comprises opening the near door leaf in a direction toward the other door leaf, of the first door leaf 18a and the second door leaf 18b. In this case, the near door leaf creates an opening, that is not against the other door leaf, but where the near door leaf meets the surrounding structure 17. Optionally, this is applied when the approach movement direction of the person 5 is larger than a second angle threshold, e.g. greater than 70 degrees, from the central direction, providing an even more convenient user experience without opening the sliding doors more than necessary.

In an optional close sliding door step 49, the door controller 1 closes the sliding door 15 such that a meeting point 20 of the first door leaf 18a and the second door leaf 18b is offset from the middle towards the predicted entry position. This is the scenario illustrated in FIG. 2C that is described above. Hence, when the doors are closed, the meeting point is adjusted to be offset from the middle of the opening, e.g. to the centre of where the person walked through (rather than symmetrically in the middle of the opening). In this way, if most people walk along the same trajectory, the opening from the offset position requires less energy and is faster.

Optionally, the meeting point is determined based on a plurality of openings of the sliding door 15, e.g. an average (or weighted average) of the last n openings, where n is a configurable number. In this way, the meeting point can automatically adapt to changing flow of people passing through the sliding door based on time of day or temporary obstacles.

FIG. 5 is a schematic diagram illustrating components of the door controller 1 of FIG. 1. It is to be noted that when the door controller 1 is implemented in a host device (such as the sliding door or electronic lock), one or more of the mentioned components can be shared with the host device. A processor 60 is provided using any combination of one or more of a suitable central processing unit (CPU), graphics processing unit (GPU), multiprocessor, microcontroller, digital signal processor (DSP), etc., capable of executing software instructions 67 stored in a memory 64, which can thus be a computer program product. The processor 60 could alternatively be implemented using an application specific integrated circuit (ASIC), field programmable gate array (FPGA), etc. The processor 60 can be configured to execute the method described with reference to FIG. 4 above.

The memory 64 can be any combination of random-access memory (RAM) and/or read-only memory (ROM). The memory 64 also comprises non-transitory persistent storage, which, for example, can be any single one or combination of magnetic memory, optical memory, solid-state memory or even remotely mounted memory.

A data memory 66 is also provided for reading and/or storing data during execution of software instructions in the processor 60. The data memory 66 can be any combination of RAM and/or ROM.

An I/O interface 62 is provided for communicating with external and/or internal entities using wired communication, e.g. based on Ethernet or Universal Serial Bus (USB), and/or wireless communication, e.g. Wi-Fi, and/or a cellular network, complying with any one or a combination of next generation mobile networks (fifth generation, 5G), LTE (Long Term Evolution), UMTS (Universal Mobile Telecommunications System) utilising W-CDMA (Wideband Code Division Multiplex), or any other current or future wireless network, as long as the principles described hereinafter are applicable.

Other components of the door controller 1 are omitted in order not to obscure the concepts presented herein.

FIG. 6 shows one example of a computer program product 90 comprising computer readable means. On this computer readable means, a computer program 91 can be stored in a non-transitory memory. The computer program can cause a processor to execute a method according to embodiments described herein. In this example, the computer program product is in the form of a removable solid-state memory, e.g. a Universal Serial Bus (USB) drive. As explained above, the computer program product could also be embodied in a memory of a device, such as the computer program product 64 of FIG. 5. While the computer program 91 is here schematically shown as a section of the removable solid-state memory, the computer program can be stored in any way which is suitable for the computer program product, such as another type of removable solid-state memory, or an optical disc, such as a CD (compact disc), a DVD (digital versatile disc) or a Blu-Ray disc.
I. A method for controlling a sliding door comprising a first door leaf and a second door leaf, the method being performed by a door controller, the method comprising: determining a position of a person approaching sliding door, in relation to the sliding door; predicting an entry position, where the person is expected to enter through the sliding door, based on the position; determining a near door leaf, being the door leaf, of the first door leaf and the second door leaf, whose centre point, in a horizontal plane, is closer to the predicted entry position, and a far door leaf being the other door leaf, of the first door leaf and the second door leaf; and opening the sliding door asymmetrically, such that a near door leaf opens more than the far door leaf.
II. The method according to embodiment I, further comprising: determining a trajectory of the person based on the position of the person in a series of images from an image capturing device 11 being fixed in relation to the sliding door; and wherein the predicting an entry position is based on the trajectory.
III. The method according to embodiment I or II, wherein the entry position is predicted to be on the side of a meeting point, of the first door leaf and the second door leaf, that is closer to the person.
IV. The method according to any one of the preceding embodiments, further comprising: closing the sliding door, such that a meeting point of the first door leaf and the second door leaf is offset from the middle towards the predicted entry position.
V. The method according to embodiment IV, wherein the meeting point is determined based on a plurality of openings of the sliding door.
VI. The method according to any one of the preceding embodiments further comprising: determining that a distance between the position 23 of the person 5 and the meeting point, of the first door leaf and the second door leaf, is less than a threshold distance; determining a desired traffic flow; and wherein the opening the sliding door asymmetrically comprises opening the sliding door such that the door leaf, of the first door leaf and the second door leaf, that complies with the traffic flow opens more than the other door leaf, of the first door leaf and the second door leaf.
VII. The method according to embodiment VI, wherein the determining a desired traffic flow comprises determining that the desired traffic flow is one of right-hand and left-hand traffic flow.
VIII. The method any one of the preceding embodiments, wherein the opening the sliding door comprises opening the near door leaf in a direction away from the other door leaf, of the first door leaf and the second door leaf.
IX. The method any one of the preceding embodiments, wherein the opening the sliding door comprises opening the near door leaf in a direction toward the other door leaf, of the first door leaf and the second door leaf.
X. A door controller for controlling a sliding door comprising a first door leaf and a second door leaf, the door controller comprising: a processor; and a memory storing instructions that, when executed by the processor, cause the door controller to: determine a position of a person approaching sliding door, in relation to the sliding door; predict an entry position, where the person is expected to enter through the sliding door, based on the position; determine a near door leaf, being the door leaf, of the first door leaf and the second door leaf, whose centre point, in a horizontal plane, is closer to the predicted entry position, and a far door leaf being the other door leaf, of the first door leaf and the second door leaf; and open the sliding door asymmetrically, such that a near door leaf opens more than the far door leaf.
XI. The door controller according to embodiment X, further comprising instructions that, when executed by the processor, cause the door controller to determine a trajectory of the person based on a series of images from an image capturing device 11 being fixed in relation to the sliding door; and wherein the instructions to predict an entry position comprise instructions that, when executed by the processor, cause the door controller to predict an entry position is based on the trajectory.
XII. The door controller according to embodiment X or XI, wherein the instructions to predict an entry position comprise instructions that, when executed by the processor, cause the door controller to predict the entry position to be on the side of a meeting point, of the first door leaf and the second door leaf, that is closer to the person.
XIII. The door controller according to any one of embodiments X to XII, further comprising instructions that, when executed by the processor, cause the door controller to: close the sliding door, such that a meeting point of the first door leaf and the second door leaf is offset from the middle towards a side of the door leaf, of the first door leaf and the second door leaf, that was opened more than the other door leaf, of the first door leaf and the second door leaf.
XIV. The door controller according to embodiment XIII, wherein the meeting point is determined based on a plurality of openings of the sliding door.
XV. The door controller according to any one of embodiments X to XIV, further comprising instructions that, when executed by the processor, cause the door controller to: determine that a distance between the position 23 of the person 5 and the meeting point, of the first door leaf and the second door leaf, is less than a threshold distance; determine a desired traffic flow; and wherein the instructions to open the sliding door asymmetrically comprise instructions that, when executed by the processor, cause the door controller to open the sliding door such that the door leaf, of the first door leaf and the second door leaf, that complies with the traffic flow opens more than the other door leaf, of the first door leaf and the second door leaf.
XVI. A sliding door comprising: a first door leaf; a second door leaf; and a door controller according to any one of embodiments X to XV for controlling the sliding door.
XVII. A computer program for controlling a sliding door comprising a first door leaf and a second door leaf, the computer program comprising computer program code which, when executed on a door controller causes the door controller to: determine a position of a person approaching sliding door, in relation to the sliding door; predict an entry position, where the person is expected to enter through the sliding door, based on the position; determine a near door leaf, being the door leaf, of the first door leaf and the second door leaf, whose centre point, in a horizontal plane, is closer to the predicted entry position, and a far door leaf being the other door leaf, of the first door leaf and the second door leaf; and open the sliding door asymmetrically, such that a near door leaf opens more than the far door leaf.
XVIII. A computer program product comprising a computer program according to embodiment XVII and a computer readable means comprising non-transitory memory in which the computer program is stored.

The aspects of the present disclosure have mainly been described above with reference to a few embodiments. However, as is readily appreciated by a person skilled in the art, other embodiments than the ones disclosed above are equally possible within the scope of the invention, as defined by the appended patent claims. Thus, while various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method for controlling a sliding door comprising a first door leaf and a second door leaf the method being performed by a door controller, the method comprising:
determining a position of a person approaching the sliding door, in relation to the sliding door;
predicting an entry position where the person is expected to enter through the sliding door, based on the position;
determining a near door leaf, being a door leaf, of the first door leaf or the second door leaf, whose centre point, in a horizontal plane, is closer to the predicted entry position, and a far door leaf being the other of the first door leaf or the second door leaf;
opening the sliding door asymmetrically, such that the near door leaf opens more than the far door leaf; and
closing the sliding door, such that a first meeting point of the first door leaf and the second door leaf after closing the sliding door is offset from a middle of the sliding door towards the predicted entry position.

2. The method according to claim 1, wherein opening the sliding door comprises starting opening of the near door leaf prior to starting opening of the far door leaf.

3. The method according to claim 1, further comprising:
determining a trajectory of the person based on the position of the person in a series of images from an image capturing device being fixed in relation to the sliding door;
wherein the predicting an the entry position is based on the trajectory.

4. The method according to claim 1, wherein the entry position is predicted to be on a side of a second meeting point of the first door leaf and the second door leaf prior to opening the sliding door that is closer to the person.

5. The method according to claim 1, wherein the first meeting point is determined based on a plurality of openings of the sliding door.

6. The method according to claim 1 further comprising:
determining that a distance between the position of the person and a second meeting point of the first door leaf and the second door leaf prior to opening the sliding door is less than a threshold distance; and
determining a desired traffic flow;
wherein opening the sliding door asymmetrically comprises opening the sliding door such that one of the first door leaf or the second door leaf that complies with the traffic flow opens more than the other of the first door leaf or the second door leaf.

7. The method according to claim 6, wherein determining the desired traffic flow comprises determining that the desired traffic flow is one of right-hand and left-hand traffic flow.

8. The method according to claim 1, wherein opening the sliding door comprises opening the near door leaf in a direction away from the far door leaf.

9. The method according to claim 1, wherein opening the sliding door comprises opening the near door leaf in a direction toward the far door leaf.

10. A door controller for controlling a sliding door comprising a first door leaf and a second door leaf, the door controller comprising:
a processor; and
a memory storing instructions that, when executed by the processor, cause the door controller to:
determine a position of a person approaching the sliding door, in relation to the sliding door;
predict an entry position, where the person is expected to enter through the sliding door, based on the position;
determine a near door leaf, being a door leaf of the first door leaf or the second door leaf whose centre point, in a horizontal plane, is closer to the predicted entry position, and a far door leaf being the other of the first door leaf or the second door leaf;
open the sliding door asymmetrically, such that the near door leaf opens more than the far door leaf; and
close the sliding door, such that a first meeting point of the first door leaf and the second door leaf after closing the sliding door is offset from a middle of the sliding door towards a first one of the first door leaf or the second door leaf that was opened more than the other of the first door leaf or the second door leaf.

11. The door controller according to claim 10, wherein the instructions to open the sliding door comprise instructions that, when executed by the processor, cause the door controller to start opening of the near door leaf prior to starting opening of the far door leaf.

12. The door controller according to claim 10, further comprising instructions that, when executed by the processor, cause the door controller to determine a trajectory of the person based on a series of images from an image capturing device being fixed in relation to the sliding door, wherein the instructions to predict the entry position comprise instructions that, when executed by the processor, cause the door controller to predict the entry position based on the trajectory.

13. The door controller according to claim 10, wherein the instructions to predict the entry position comprise instructions that, when executed by the processor, cause the door controller to predict the entry position to be on a side of a second meeting point of the first door leaf and the second door leaf prior to opening the sliding door that is closer to the person.

14. The door controller according to claim 10, wherein the first meeting point is determined based on a plurality of openings of the sliding door.

15. The door controller according to claim 10, further comprising instructions that, when executed by the processor, cause the door controller to:
determine that a distance between the position of the person and a second meeting point of the first door leaf and the second door leaf prior to opening of the sliding door is less than a threshold distance; and
determine a desired traffic flow;
wherein the instructions to open the sliding door asymmetrically comprise instructions that, when executed by the processor, cause the door controller to open the sliding door such that one of the first door leaf or the second door leaf that complies with the traffic flow opens more than the other of the first door leaf or the second door leaf.

16. A sliding door comprising:
a door controller according to claim 10 for controlling the sliding door;
the first door leaf; and
the second door leaf.

17. A non-transitory computer readable medium storing a computer program for controlling a sliding door comprising a first door leaf and a second door leaf, the computer program comprising computer program code which, when executed on a door controller, causes the door controller to:
determine a position of a person approaching the sliding door, in relation to the sliding door;
predict an entry position, where the person is expected to enter through the sliding door, based on the position;
determine a near door leaf, being a door leaf of the first door leaf or the second door leaf whose centre point, in a horizontal plane, is closer to the predicted entry position, and a far door leaf being the other of the first door leaf or the second door leaf;
open the sliding door asymmetrically, such that the near door leaf opens more than the far door leaf; and
close the sliding door, such that a meeting point of the first door leaf and the second door leaf is offset from a middle of the sliding door towards a first one of the first door leaf or the second door leaf that was opened more than the other of the first door leaf or the second door leaf.

18. (canceled)
